(19) United States
(12) Patent Application Publication
(10) Pub. No.: US 2001/0025835 A1
(43) Pub. Date: Oct. 4, 2001

(54) Camouflage denim products

(76) Inventor: Darryl Costin JR., Lakewood, OH (US)

Correspondence Address: SCOTT C HARRIS, P O BOX 927649, SAN DIEGO, CA, 92192, US

(21) Appl. No.: 09/736,958

(22) Filed: Dec. 14, 2000

Related U.S. Application Data
(60) Provisional application No. 60/170,827, filed on Dec. 14, 1999.

(51) Int. Cl. B23K 26/00

(52) U.S. Cl. 219/121.69

(57) ABSTRACT

A technique is disclosed of forming an irregular pattern, such as a camouflage pattern on a user interface. The camouflage pattern is formed in a number of different colors, each color being associated with a specified laser power. Each laser power produces a different amount of color change to a garment. In this way, a camouflage pattern can be formed on the garment.

### CROSS REFERENCE TO RELATED APPLICATIONS

This application claims the benefit of the U.S. Provisional Application No. 60/170,827, filed on Dec. 14, 1999.

### BACKGROUND

Denim jeans are basically differentiated by material color. Although there are many variations on these themes such as boot cut, sandblasted, and baggie, the denim industry still manufacturers very few styles of denim.

### SUMMARY

The present system teaches using a laser to prepare a new kind of material which includes unique patterns, such as camouflage patterns, thereon.

In one embodiment, a camouflage pattern is defined, and a computer file is formed that is indicative of the pattern. The computer file is used to control a laser beam to draw a pattern on a textile material. The pattern has lighter and darker areas, in the shape of the pattern, based on the computer file.

### BRIEF DESCRIPTION OF THE DRAWINGS

These and other aspects of the invention will be described in detail with reference to the accompanying drawings, wherein:

FIG. 1 shows a basic camouflage pattern;

FIG. 2 shows a block diagram of a hardware setup for forming the patterns, and transferring them to apparel; and

FIG. 3 shows a basic flowchart of operation.

### DETAILED DESCRIPTION

In the present system, lasers are used to create different designs on denim. This can be done in either a continuous process where the laser scribes patterns on a roll of denim fabric, or in a unit process where a laser scribes patterns on individual clothing items—e.g. individual denim jeans or shirts. The laser is used to scribe graphic images on fabrics in a unique way, which allows for individual laser scans to be drawn at different energy intensities along any single line, and from line to line.

Each of the lines as drawn can abrade the denim, and thereby change the look of the denim where it contacts the denim. This enables forming designs on the denim, e.g., by scribing lines, or defining areas whose colors are to be changed, and scribing changes to the material within those areas.

The present invention describes using a laser to change the look of a textile material, e.g. a denim garment. A camouflage pattern is formed on denim products using the techniques described in U.S. Pat. Nos. 6,002,099 and 5,916,461 which allow the user to paint the image to be lazed on the computer screen.

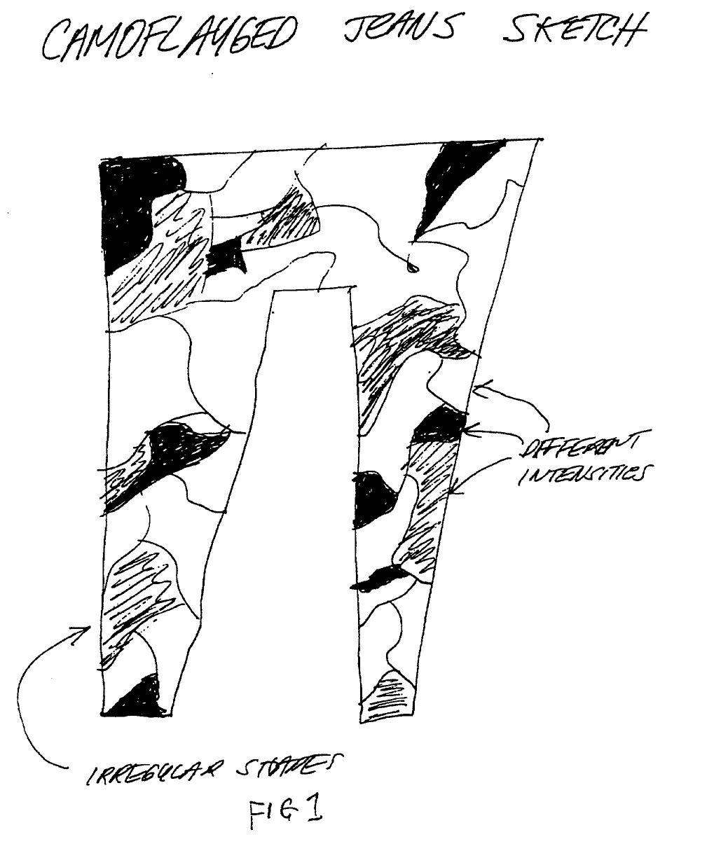

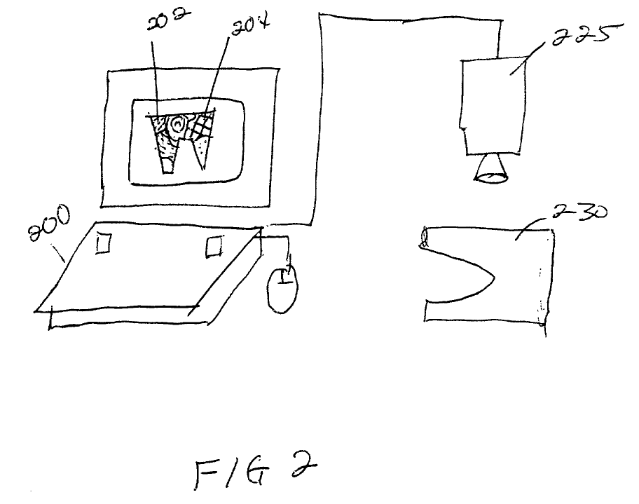

A camouflage pattern can be created using this technique. A sample camouflage pattern is shown in FIG. 1. The program operates using the hardware shown in FIG. 2. A user interface 200 allows the user the option of using different colors 202, 204; e.g ten colors; more preferably 5-20 colors; to draw a pattern. Each color is assigned a user-defined power (or duty cycle) level of driving a laser 225. This different power causes a different look on the actual denim product being lased 230.

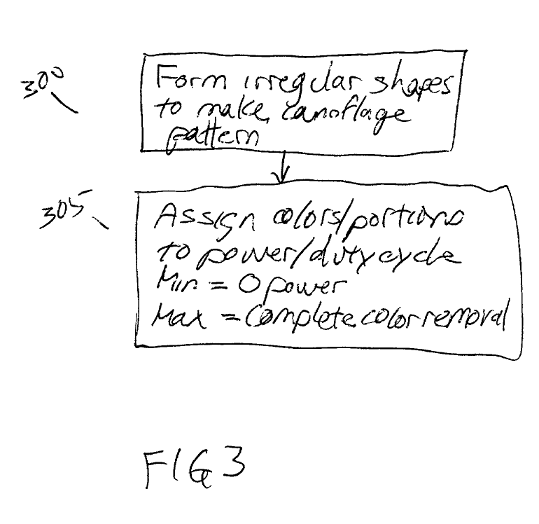

The process may follow the flowchart of FIG. 3. At 300, a pattern is designed using connected irregular shapes that replicate the camouflage pattern. The objects drawn should represent a camouflage type design with random shapes and colors. A series of irregular shapes can be drawn by the designer at 300. Alternatively, the program can postulate some shapes using a random number generator, seeded by some cue from the user. In this latter way, each garment becomes unique and different than each other garment.

Once the pattern is designed, the user can assign each color to a laser power level, or duty cycle level at 305. Every color should represent a different power (or duty cycle). When the material is lazed with this pattern, the lazed product attains the appearance of a camouflaged look.

If the material is indigo denim, the different shapes have different levels of white or blue appearance due the action of the laser scribing the different shapes at different power (or duty cycle) levels. Therefore, when looking at the garment, some objects will appear more intense while others will be less intense. This provides more of a feathered type appearance. However, it is important to note that the colors given a lower power (or duty cycle) must be high enough to the point where the EDPUT (energy density per unit time) is sufficient to allow the “image” to change to the material, or be visible after washing.

The areas of the pattern which use a color representing zero power (or duty cycle) will appear indigo (the natural denim color), and the areas of the pattern which use a color representing the maximum power (or duty cycle) will appear white or close to white. The areas of the pattern which use a color in between these two levels will appear between these two colors and at different color intensities. This effect simulates a grayscale image.

Since the laser can scribe such a camouflage pattern continuously along a web of denim fabric or on individual units such as jeans, the process to apply such a unique design may be cost effective. Further, since the lazed camouflage pattern looks particularly good on the denim after a conventional home wash, it is possible to eliminate one of the costly steps in the production of denim jeans—the enzyme wash or stone wash process.

While the present disclosure describes a camouflaged pattern, this is just exemplary of the patterns that can be formed. The basic idea is to form a pattern that is totally unique to the one denim product, and a pattern that no one else will have on their jeans. The patterns are not limited to camouflage, but may also include other irregular shapes, in multiple colors and in single colors. The shapes can be rounded, polygonal, or made in any other geometric shape. Cow-type spots, polka dots, irregular strips, plaid patterns, and others are contemplated.

Although only a few embodiments have been disclosed in detail above, other modifications are possible. For example, while the above describes in detail only forming a camouflage pattern, it should be understood that other unique patterns can also be formed. In addition, other materials besides denim can be used. All such modifications are intended to be encompassed within the following claims, in which:

What is claimed is:

1. A method, comprising:
defining a camouflage pattern using a user interface associated with an automated computer and producing an output file indicative thereof; and
using said output file to control a laser to form said camouflage pattern on a textile material.

2. A method as in claim 1, wherein said defining comprises defining a unique output file which is unique for a single application to the textile material.

3. A method as in claim 1, wherein said defining comprises forming an image having a plurality of different portions therein, associating each said portion with a power output of the laser, to thereby produce power outputs from said lasers based on said portions.

4. A method as in claim 3, wherein each said portion is a specified color.

5. A method as in claim 4, wherein said camouflage pattern includes a plurality of random shapes and colors.

6. A method as in claim 3, wherein each laser power output is a duty cycle output.

7. A method as in claim 3, wherein each laser power output is a specified level of energy density per unit time.

8. A method as in claim 1, wherein said textile material is denim material.

9. A method as in claim 3, wherein the laser is controlled to scan in lines, and at least one of said lines has a varying power within the line.

10. A method as in claim 1, wherein said defining comprises using a random number generator to form the shapes.

11. A method as in claim 1, wherein said defining comprises drawing a pattern in a plurality of different colors, and assigning each color of the pattern to a specified laser power.

12. A method as in claim 11, wherein said assigning comprises determining a minimum laser power which will not change a look of the material, and determining a maximum laser power which causes a maximum amount of change to the look of the material, and defining intermediate laser powers between said maximum and minimum laser power.

13. A method, comprising:
defining a unique shape and producing an output file indicative thereof, said unique shape being unique to a single output file; and
using said output file to control a laser to produce said unique shape on a textile material to produce a unique textile material.

14. A method as in claim 13, wherein said unique shape includes a plurality of areas, each of the plurality of areas being defined by a different color, and each color associated with a different laser power.

15. A method as in claim 14, wherein said laser power is an energy density per unit time.

16. A method as in claim 14 wherein said laser power is a duty cycle.

17. A method as in claim 14 wherein said output file is a file that instructs said laser to scribe lines on the fabric, wherein at least one of said lines has a power that varies within the line.

18. A method as in claim 14, wherein there are between 5 and 20 different colors.

19. A method as in claim 13, wherein said unique shape is a camouflage shape.

20. A method as in claim 13, wherein said unique shape has rounded edges.

21. A method as in claim 13, wherein said unique shape is formed of polygonal portions.

22. A method as in claim 13, wherein said shapes define cow type spots.

23. A method as in claim 13, wherein said shape define irregularly positioned polka dots.

24. A method as in claim 13, wherein said shapes define a regular strips.

25. A method as in claim 13, wherein said defining a unique shape comprises using a random number generator to define said unique shape.

26. A method as in claim 13, further comprising defining a minimum output power which produces minimum color change to the garment at a minimum power, defining a maximum power level as a power level which causes a maximum amount of color change to the garment, and defining a plurality of intermediate power levels between said minimum and maximum power levels.

27. A method as in claim 26, further comprising assigning each of said power levels to a color on the user interface.

28. A method as in claim 27, wherein said unique shape is a camouflage pattern with a plurality of rounded edges.

29. A method as in claim 13, wherein said textile material is denim.

30. A method as in claim 13, wherein said laser is used to form said image on denim jeans.

31. A method as in claim 27, wherein said unique shape is a plaid pattern.
